(19) United States
(12) Patent Application Publication
(10) Pub. No.: US 2026/0342224 A1
(43) Pub. Date: Oct. 29, 2026

(54) RESONANT SWITCHED-CAPACITOR POWER CONVERTER HAVING MULTIPLE INDUCTORS AND OPERATING METHOD THEREOF

(71) Applicant: RICHTEK TECHNOLOGY CORP., Hsinchu County (TW)

(72) Inventors: Kuo-Chi Liu, Hsinchu City (TW); Shui-Mu Lin, Taichung City (TW)

(21) Appl. No.: 19/688,503

(22) Filed: May 26, 2026

Related U.S. Application Data
(60) Provisional application No. 63/976,995, filed on Feb. 6, 2026.

(51) Int. Cl. H02M 3/07; H02M 1/00; H02M 1/38; H02M 3/00

(52) U.S. Cl. CPC H02M 3/07; H02M 1/0043; H02M 1/0058; H02M 1/0095; H02M 1/38; H02M 3/01

(57) ABSTRACT

A method of operating a switched-capacitor power converter includes controlling switches during a first on-time to couple a first inductor, a second inductor, and at least two flying capacitors in series between an input node and an output node. The method further includes controlling the switches during a second on-time to couple the at least two flying capacitors in parallel with each other and in series with the second inductor between the output node and a ground.

### CROSS REFERENCE TO RELATED APPLICATIONS

This application claims the benefit of U.S. Provisional Application No. 63/976,995, filed on Feb. 6, 2026. The content of the application is incorporated herein by reference.

### BACKGROUND OF THE INVENTION

### 1. Field of the Invention

The present disclosure relates to a switched-capacitor power converter and an operating method thereof, and more particularly, to a resonant switched-capacitor power converter having at least two inductors and an operating method thereof.

### 2. Description of the Prior Art

Power converters are used in electronic devices that receive power at one voltage level and provide power at another voltage level for circuit operation. For example, a power converter can be adopted in a mobile device, a computing device, a communication device, or another electronic system having limited circuit area and thermal budget. As a demand for higher power density increases, a power converter is expected to provide conversion with reduced circuit area, reduced component size, and reduced temperature rise while maintaining stable electrical behavior.

A switched-capacitor power converter can transfer energy by selectively connecting flying capacitors through switches. A conversion ratio of the switched-capacitor power converter can be associated with a series-parallel connection relationship of the flying capacitors. A resonant operation can be introduced by arranging inductance in a current path of the switched-capacitor power converter. The resonant operation can shape current waveforms of the flying capacitors and the inductors, and can be coordinated with a switching timing of the switches.

During a transition between switching states, voltage deviations accumulated on flying capacitors can produce transient currents through internal capacitor paths. When a plurality of flying capacitors are connected in series, the voltage deviations of the plurality of flying capacitors can be accumulated. The accumulated voltage deviation can cause switching current peaks, power loss, and thermal stress. The position of the inductance in the resonant path and the on-time control of the switches affect whether the transient currents are distributed through the resonant path. Therefore, providing a switched-capacitor power converter and an operating method that support resonant operation, multiple conversion modes, and zero-current switching remains a design issue.

### SUMMARY OF THE INVENTION

In an embodiment, a method of operating a switched-capacitor power converter for converting power between an input node and an output node is disclosed. The switched-capacitor power converter comprises a controller, a plurality of switches, a first inductor, a second inductor, and at least two flying capacitors. The method comprises controlling, by the controller, the plurality of switches during a first on-time to couple the first inductor, the second inductor, and the at least two flying capacitors in series between the input node and the output node; and controlling, by the controller, the plurality of switches during a second on-time to couple the at least two flying capacitors in parallel with each other and in series with the second inductor between the output node and a ground.

In another embodiment, a switched-capacitor power converter is disclosed. The switched-capacitor power converter comprises an input node, an output node, a power stage, and a controller. The power stage is coupled between the input node and the output node. The power stage comprises a plurality of switches, a first inductor, a second inductor, and at least two flying capacitors. The controller is coupled to the plurality of switches and configured to control the plurality of switches during a first on-time to couple the first inductor, the second inductor, and the at least two flying capacitors in series between the input node and the output node, and to control the plurality of switches during a second on-time to couple the at least two flying capacitors in parallel with each other and in series with the second inductor between the output node and a ground.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a switched-capacitor power converter according to an embodiment of the present disclosure.

FIG. 2 is a circuit diagram of a power stage of a 4:1 resonant switched-capacitor power converter according to an embodiment of the present disclosure.

FIG. 3 is a circuit diagram of another power stage of a 4:1 resonant switched-capacitor power converter according to an embodiment of the present disclosure.

FIG. 4A is an equivalent circuit diagram of the switched-capacitor power converter operating during a first on-time according to an embodiment of the present disclosure.

FIG. 4B is an equivalent circuit diagram of the switched-capacitor power converter operating during a second on-time according to an embodiment of the present disclosure.

FIG. 5 is a circuit diagram of a dual-phase resonant switched-capacitor power converter according to an embodiment of the present disclosure.

FIG. 6 is a circuit diagram of another power stage of a dual-phase resonant switched-capacitor power converter according to an embodiment of the present disclosure.

FIG. 7A is a circuit diagram illustrating a first switching state of the dual-phase resonant switched-capacitor power converter operating in a 4:1 resonant mode according to an embodiment of the present disclosure.

FIG. 7B is a circuit diagram illustrating a second switching state of the dual-phase resonant switched-capacitor power converter operating in the 4:1 resonant mode according to an embodiment of the present disclosure.

FIG. 8 is a circuit diagram of a zero-current switching detection circuit and an on-time generator according to an embodiment of the present disclosure.

FIG. 9 is a waveform diagram of switching control signals and waveforms of the dual-phase resonant switched-capacitor power converter operating in the 4:1 resonant mode according to an embodiment of the present disclosure.

FIG. 10A is a circuit diagram illustrating a third switching state of the dual-phase resonant switched-capacitor power converter operating in a 3:1 resonant mode according to an embodiment of the present disclosure.

FIG. 10B is a circuit diagram illustrating a fourth switching state of the dual-phase resonant switched-capacitor power converter operating in the 3:1 resonant mode according to an embodiment of the present disclosure.

FIG. 11 is a waveform diagram of switching control signals and waveforms of the dual-phase resonant switched-capacitor power converter operating in the 3:1 resonant mode according to an embodiment of the present disclosure.

FIG. 12 is a simulation waveform diagram of the dual-phase resonant switched-capacitor power converter operating in the 4:1 resonant mode with a first inductor and a second inductor according to an embodiment of the present disclosure.

FIG. 13 is a simulation waveform diagram of the dual-phase resonant switched-capacitor power converter operating in the 4:1 resonant mode without the first inductor according to an embodiment of the present disclosure.

FIG. 14 is a flowchart illustrating a method of operating the switched-capacitor power converter according to an embodiment of the present disclosure.

### DETAILED DESCRIPTION

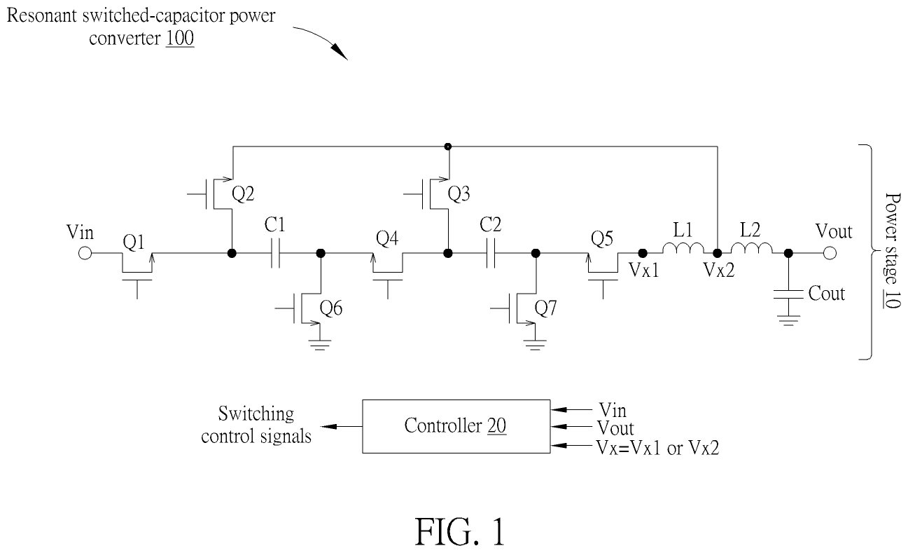

FIG. 1 is a circuit diagram of a switched-capacitor power converter 100 according to an embodiment of the present disclosure. FIG. 1 shows that the switched-capacitor power converter 100 can operate in a 3:1 resonant mode using two flying capacitors C1 and C2. The switched-capacitor power converter 100 includes a power stage 10 and a controller 20. The power stage 10 is coupled between an input node receiving an input voltage Vin and an output node providing an output voltage Vout. The power stage 10 includes a plurality of switches Q1 to Q7, a first inductor L1, a second inductor L2, the two flying capacitors C1 and C2, and an output capacitor Cout. The two flying capacitors C1 and C2 correspond to at least two flying capacitors of the switched-capacitor power converter 100. The output capacitor Cout is coupled between the output node and a ground, and the output capacitor Cout can stabilize the output voltage Vout. The controller 20 is coupled to the plurality of switches Q1 to Q7 and is configured to generate switching control signals for controlling the plurality of switches Q1 to Q7. The controller 20 can receive the input voltage Vin, the output voltage Vout, and a voltage of the switch node Vx. The switch node Vx can be the first switch node Vx1 or the second switch node Vx2.

The switches Q1 to Q7 selectively configure the flying capacitors C1 and C2 into different connection states. During a first on-time, the controller 20 controls the switches Q1 to Q7 so that the flying capacitor C1 and the flying capacitor C2 are coupled in series with each other. The first inductor L1 and the second inductor L2 are also located in a first on-time current path. Therefore, the first on-time current path extends from the input node through the flying capacitor C1, the flying capacitor C2, the first inductor L1, and the second inductor L2 toward the output node. The first on-time current path corresponds to a series charging path of the flying capacitors C1 and C2. A resonant path during the first on-time includes the first inductor L1, the second inductor L2, and the series-connected flying capacitors C1 and C2.

During a second on-time, the controller 20 controls the switches Q1 to Q7 so that the flying capacitor C1 and the flying capacitor C2 are coupled in parallel with each other. The parallel-connected flying capacitors C1 and C2 are coupled in series with the second inductor L2 between the output node and the ground. Therefore, the flying capacitors C1 and C2 discharge through the second inductor L2 toward the output node. The first inductor L1 is not included in an equivalent resonant path during the second on-time. Accordingly, the first on-time resonant path includes both the first inductor L1 and the second inductor L2, while the second on-time resonant path includes the second inductor L2 without the first inductor L1.

In the 3:1 resonant mode, an equivalent capacitance of the first on-time resonant path is associated with the flying capacitors C1 and C2 connected in series, and an equivalent inductance of the first on-time resonant path is associated with the first inductor L1 and the second inductor L2. An equivalent capacitance of the second on-time resonant path is associated with the flying capacitors C1 and C2 connected in parallel, and an equivalent inductance of the second on-time resonant path is associated with the second inductor L2. The first on-time and the second on-time can be determined based on corresponding resonant periods. The controller 20 can adjust the first on-time and the second on-time based on a zero-current switching detection result so that an inductor current of the second inductor L2 reaches a zero-current level during dead-time periods following the first on-time and the second on-time.

The voltage of the switch node Vx can be used for zero-current switching detection. The controller 20 can sense the voltage of the switch node Vx and generate a sensed voltage signal based on the voltage of the switch node Vx. The controller 20 can compare the sensed voltage signal with reference voltages generated based on the output voltage Vout, and can determine whether a present switching timing is early, late, or close to a zero-current switching state. The controller 20 can then adjust an on-time of a subsequent switching cycle. The first inductor L1 and the second inductor L2 are not limited to discrete inductor components. At least one of the first inductor L1 and the second inductor L2 can be formed by a conductive path of a printed circuit board, a conductive path of an integrated circuit, a package lead, or another conductive structure having an inductance effect.

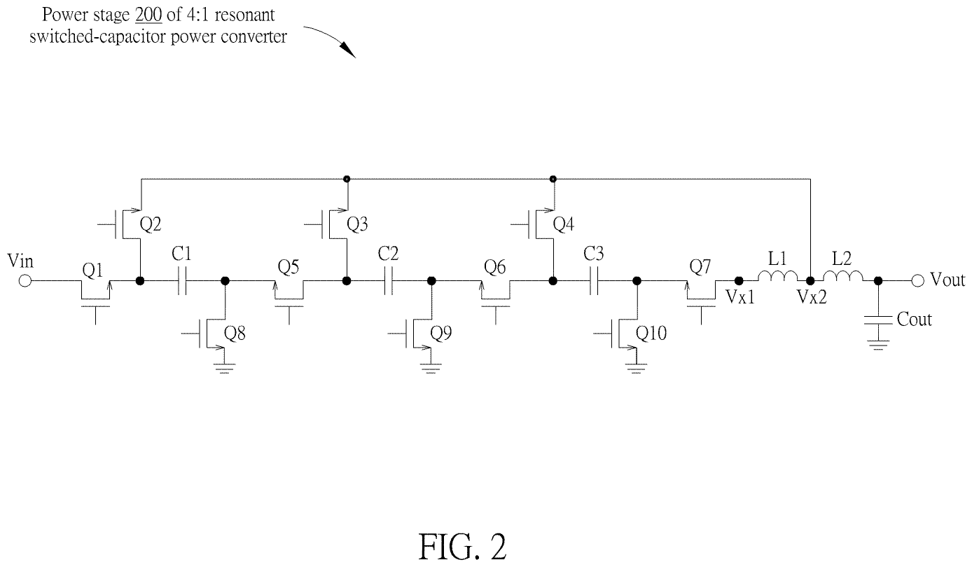

FIG. 2 is a circuit diagram of a power stage 200 of a 4:1 resonant switched-capacitor power converter according to an embodiment of the present disclosure. FIG. 2 shows that the 3:1 resonant mode shown in FIG. 1 can be extended to a 4:1 resonant mode by increasing the number of flying capacitors from two to three. The power stage 200 includes switches Q1 to Q10, a first inductor L1, a second inductor L2, flying capacitors C1 to C3, and an output capacitor Cout. The power stage 200 is coupled between an input node receiving an input voltage Vin and an output node providing an output voltage Vout. The output capacitor Cout is coupled between the output node and the ground. The power stage 200 can be controlled by a controller, such as the controller 20 shown in FIG. 1.

The power stage 200 includes a series-parallel switched-capacitor network formed by the flying capacitors C1 to C3 and the switches Q1 to Q10. The switch Q1 is coupled between the input node and one side of the flying capacitor C1. The switch Q5 is coupled between another side of the flying capacitor C1 and one side of the flying capacitor C2. The switch Q6 is coupled between another side of the flying capacitor C2 and one side of the flying capacitor C3. The switch Q7 is coupled between another side of the flying capacitor C3 and a node coupled to the first inductor L1. The first inductor L1 is coupled between the node connected to the switch Q7 and the second switch node Vx2. The second inductor L2 is coupled between the second switch node Vx2 and the output node. The switches Q2, Q3, and Q4 are arranged to couple corresponding capacitor nodes to an upper bus leading to the second switch node Vx2 during a parallel discharging state. The switches Q8, Q9, and Q10 are arranged to couple corresponding capacitor nodes to the ground during the parallel discharging state.

During a first on-time of the power stage 200, the switches Q1, Q5, Q6, and Q7 are turned on, and the switches Q2, Q3, Q4, Q8, Q9, and Q10 are turned off. A first on-time current path extends from the input node through the switch Q1, the flying capacitor C1, the switch Q5, the flying capacitor C2, the switch Q6, the flying capacitor C3, the switch Q7, the first inductor L1, the second switch node Vx2, the second inductor L2, and the output node. The flying capacitors C1 to C3 are coupled in series with each other and with the first inductor L1 and the second inductor L2 between the input node and the output node. Therefore, the flying capacitors C1 to C3 are charged in series through a resonant path including the first inductor L1 and the second inductor L2.

During a second on-time of the power stage 200, the switches Q2, Q3, Q4, Q8, Q9, and Q10 are turned on, and the switches Q1, Q5, Q6, and Q7 are turned off. The switches Q2, Q3, and Q4 couple upper terminals of the flying capacitors C1 to C3 to the upper bus and the second switch node Vx2. The switches Q8, Q9, and Q10 couple lower terminals of the flying capacitors C1 to C3 to the ground. Accordingly, the flying capacitors C1 to C3 are coupled in parallel with each other. The parallel-connected flying capacitors C1 to C3 are coupled in series with the second inductor L2 between the output node and the ground. In the second on-time, the flying capacitors C1 to C3 discharge through the second inductor L2 toward the output node, and the first inductor L1 is bypassed from the equivalent resonant path.

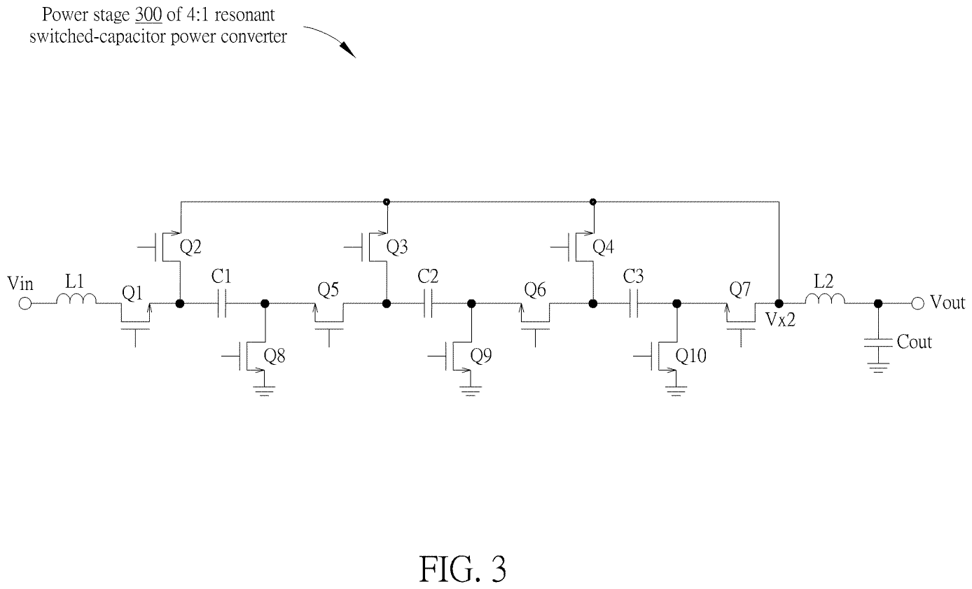

FIG. 3 is a circuit diagram of another power stage 300 of a 4:1 resonant switched-capacitor power converter according to an embodiment of the present disclosure. FIG. 3 shows another arrangement of the first inductor L1 in a 4:1 resonant switched-capacitor power converter. The power stage 300 includes switches Q1 to Q10, the first inductor L1, a second inductor L2, flying capacitors C1 to C3, and an output capacitor Cout. The first inductor L1 is coupled between the input node receiving the input voltage Vin and the switch Q1. The second inductor L2 is coupled between the second switch node Vx2 and the output node providing the output voltage Vout.

During the first on-time of the power stage 300, a first on-time current path extends from the input node through the first inductor L1, the switch Q1, the flying capacitor C1, the switch Q5, the flying capacitor C2, the switch Q6, the flying capacitor C3, the switch Q7, the second switch node Vx2, the second inductor L2, and the output node. Therefore, the flying capacitors C1 to C3 are coupled in series with each other and with the first inductor L1 and the second inductor L2 between the input node and the output node. The first on-time resonant path of the power stage 300 includes the first inductor L1 and the second inductor L2.

During the second on-time of the power stage 300, the switches Q2, Q3, Q4, Q8, Q9, and Q10 can couple the flying capacitors C1 to C3 in parallel with each other. The parallel-connected flying capacitors C1 to C3 are coupled in series with the second inductor L2 between the output node and the ground. The first inductor L1 is not included in the equivalent resonant path during the second on-time. Since the first inductor L1 and the second inductor L2 are both included in the first on-time series charging path, the first inductor L1 can be placed between the input node and the switch Q1 as shown in FIG. 3 or between the switch Q7 and the second switch node Vx2 as shown in FIG. 2. The placement of the first inductor L1 can be selected based on layout, package, or printed circuit board routing requirements while maintaining the same resonant path relationship.

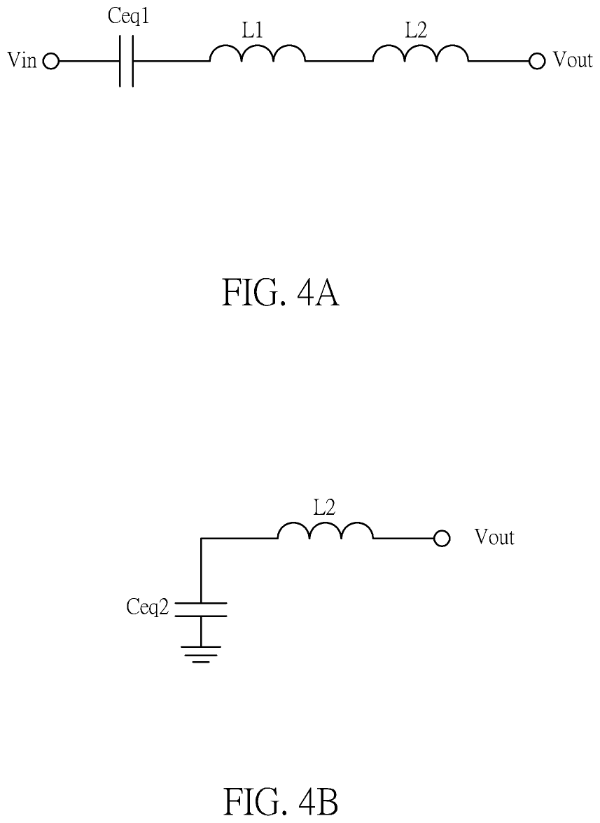

FIG. 4A is an equivalent circuit diagram of the switched-capacitor power converter operating during a first on-time according to an embodiment of the present disclosure. In FIG. 4A, a series equivalent capacitance Ceq1 represents an equivalent capacitance of flying capacitors connected in series during the first on-time. The series equivalent capacitance Ceq1, the first inductor L1, and the second inductor L2 are coupled in series between the input node receiving the input voltage Vin and the output node providing the output voltage Vout. The equivalent circuit of FIG. 4A corresponds to the series charging state of FIG. 1, FIG. 2, and FIG. 3.

In the equivalent circuit of FIG. 4A, a first resonant frequency is associated with the first inductor L1, the second inductor L2, and the series equivalent capacitance Ceq1. A first resonant period corresponding to the first resonant frequency can be used for determining the first on-time. When two flying capacitors are connected in series, the series equivalent capacitance Ceq1 corresponds to the equivalent capacitance of the two flying capacitors. When three flying capacitors are connected in series, the series equivalent capacitance Ceq1 corresponds to the equivalent capacitance of the three flying capacitors. In some embodiments, the first on-time can be set to about one half of the first resonant period. In other embodiments, the first on-time can be adjusted around the first resonant period based on a zero-current switching detection result, a switching state signal, a dead-time setting, or another control parameter of the controller.

FIG. 4B is an equivalent circuit diagram of the switched-capacitor power converter operating during a second on-time according to an embodiment of the present disclosure. In FIG. 4B, a parallel equivalent capacitance Ceq2 represents an equivalent capacitance of flying capacitors connected in parallel during the second on-time. The parallel equivalent capacitance Ceq2 and the second inductor L2 form an equivalent resonant path between the output node providing the output voltage Vout and the ground. The first inductor L1 is not included in the equivalent resonant path of FIG. 4B. The equivalent circuit of FIG. 4B corresponds to the parallel discharging state of FIG. 1, FIG. 2, and FIG. 3.

In the equivalent circuit of FIG. 4B, a second resonant frequency is associated with the second inductor L2 and the parallel equivalent capacitance Ceq2. A second resonant period corresponding to the second resonant frequency can be used for determining the second on-time. In some embodiments, the first resonant period and the second resonant period can be substantially equal so that the first on-time and the second on-time can be coordinated. When flying capacitors have substantially the same capacitance, the inductance of the first inductor L1 can be greater than the inductance of the second inductor L2. For example, in a single-phase 3:1 resonant mode using two flying capacitors in the series charging path, the inductance of the first inductor L1 can be about three times the inductance of the second inductor L2. In a 4:1 resonant mode using three flying capacitors in the series charging path, the inductance of the first inductor L1 can be about eight times the inductance of the second inductor L2. The numerical relationships are illustrative design conditions and do not limit the scope of the present disclosure. Derivation details are illustrated below.

The relationship between the first inductor L1 and the second inductor L2 can be derived from the first resonant frequency and the second resonant frequency. The first resonant frequency fᵣₑₛ₁ of the equivalent circuit shown in FIG. 4A can be expressed as:

$${f}_{res 1} = \frac{1}{2 π \sqrt{( {L}_{1} + {L}_{2} ) \times {C}_{e q 1}}}$$

where C_{eq1} is the series equivalent capacitance of the flying capacitors connected in series during the first on-time. The second resonant frequency fᵣₑₛ₂ of the equivalent circuit shown in FIG. 4B can be expressed as:

$${f}_{res 2} = \frac{1}{2 π \sqrt{{L}_{2} \times {C}_{e q 2}}}$$

where C_{eq2} is the parallel equivalent capacitance of the flying capacitors connected in parallel during the second on-time. When the first resonant period and the second resonant period are designed to be substantially equal, the first resonant frequency fᵣₑₛ₁ and the second resonant frequency fᵣₑₛ₂ can be substantially equal. Therefore, the following relationship can be obtained:

(L₁+L²)×C_{eq1}=L₂×C_{eq2}

Assume that the flying capacitors have the same capacitance Cᵣ. In the 3:1 resonant mode using two flying capacitors, the two flying capacitors are connected in series during the first on-time and connected in parallel during the second on-time. Accordingly, the series equivalent capacitance C_{eq1}=Cᵣ/2, and the parallel equivalent capacitance C_{eq2}=2Cᵣ. Substituting C_{eq1}=Cᵣ/2 and C_{eq2}=2Cᵣ into the above equation gives:

(L₁+L₂)×(Cᵣ/2)=L₂×2Cᵣ

Thus, the inductance of the first inductor L1 can be expressed as:

L₁=3L₂

In the 4:1 resonant mode using three flying capacitors, the three flying capacitors are connected in series during the first on-time and connected in parallel during the second on-time. Accordingly, the series equivalent capacitance C_{eq1}=Cᵣ/3, and the parallel equivalent capacitance C_{eq2} is 3Cᵣ. Substituting C_{eq1}=Cᵣ/3 and C_{eq2}=3Cᵣ into the above equation gives:

(L₁+L₂)×(Cᵣ/3)=L₂×3Cᵣ

Thus, the inductance of the first inductor L1 can be expressed as:

L₁=8L₂

Accordingly, when the first resonant frequency fᵣₑₛ₁ and the second resonant frequency fᵣₑₛ₂ are designed to be substantially equal, the inductance of the first inductor L1 can be greater than the inductance of the second inductor L2. In the 3:1 resonant mode, the inductance of the first inductor L1 can be about three times the inductance of the second inductor L2. In the 4:1 resonant mode, the inductance of the first inductor L1 can be about eight times the inductance of the second inductor L2.

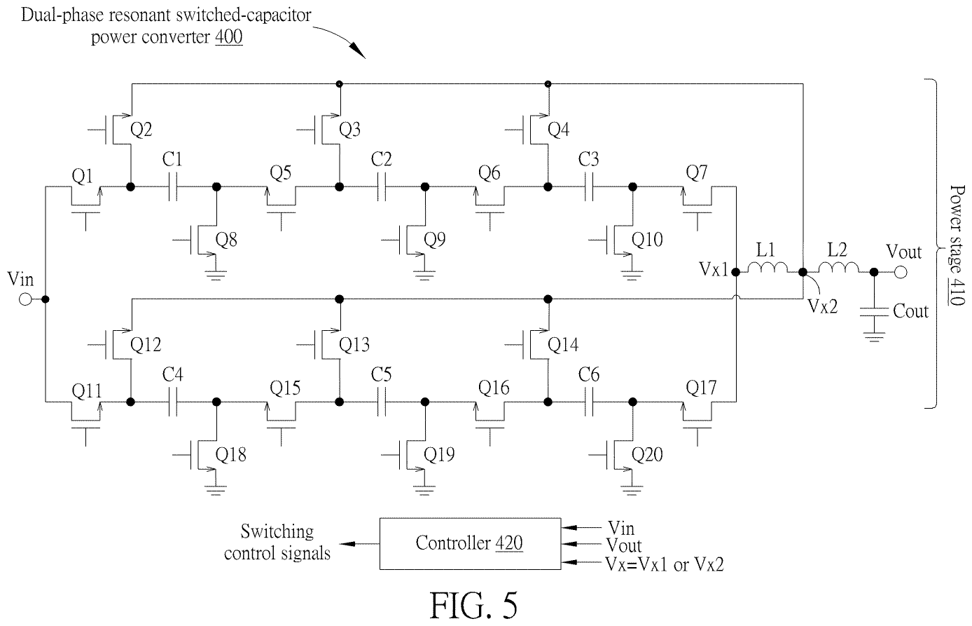

FIG. 5 is a circuit diagram of a dual-phase resonant switched-capacitor power converter 400 according to an embodiment of the present disclosure. The dual-phase resonant switched-capacitor power converter 400 includes a power stage 410 and a controller 420. The power stage 410 includes a first phase switched-capacitor circuit, a second phase switched-capacitor circuit, a first inductor L1, a second inductor L2, and an output capacitor Cout. The first phase switched-capacitor circuit includes switches Q1 to Q10 and flying capacitors C1 to C3. The second phase switched-capacitor circuit includes switches Q11 to Q20 and flying capacitors C4 to C6.

The first phase switched-capacitor circuit and the second phase switched-capacitor circuit are arranged in parallel between the input node and a shared resonant-inductor path. The first inductor L1 and the second inductor L2 are shared by the first phase switched-capacitor circuit and the second phase switched-capacitor circuit. The controller 420 receives the input voltage Vin, the output voltage Vout, and a voltage of the switch node Vx. The switch node Vx can be the first switch node Vx1 or the second switch node Vx2. The controller 420 generates switching control signals S1 to S20 for controlling the switches Q1 to Q20.

The controller 420 can operate the first phase switched-capacitor circuit and the second phase switched-capacitor circuit with a phase shift. For example, the first phase switched-capacitor circuit and the second phase switched-capacitor circuit can be operated with a phase shift of 180 degrees. When the flying capacitors C1 to C3 of the first phase switched-capacitor circuit are connected in series, the flying capacitors C4 to C6 of the second phase switched-capacitor circuit can be connected in parallel. When the flying capacitors C4 to C6 of the second phase switched-capacitor circuit are connected in series, the flying capacitors C1 to C3 of the first phase switched-capacitor circuit can be connected in parallel. Therefore, one phase can perform series charging while another phase performs parallel discharging.

In the 4:1 resonant mode of FIG. 5, a phase having three series-connected flying capacitors uses a resonant path including both the first inductor L1 and the second inductor L2. A phase having three parallel-connected flying capacitors uses a resonant path including the second inductor L2. The two phases alternately use the equivalent resonant circuits described with reference to FIG. 4A and FIG. 4B. The dual-phase resonant switched-capacitor power converter 400 can be configured for different resonant modes. In a 4:1 resonant mode, three flying capacitors of a phase participate in the series-parallel operation. In a 3:1 resonant mode, one flying capacitor of each phase is disabled, and the remaining two flying capacitors of each phase participate in the operation. In a 2:1 resonant mode, two flying capacitors of each phase are disabled, and one remaining flying capacitor of each phase participates in the operation.

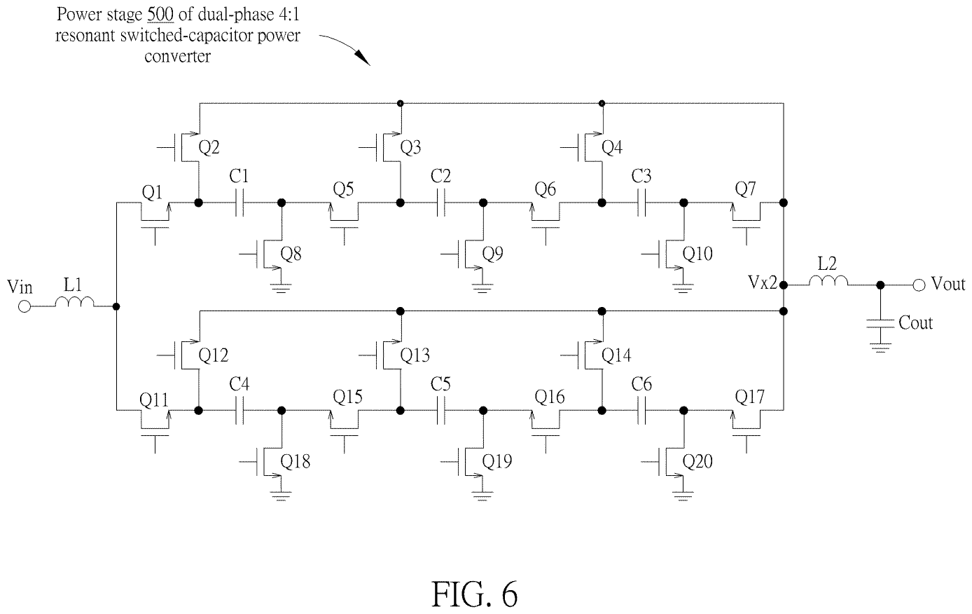

FIG. 6 is a circuit diagram of another power stage 500 of a dual-phase resonant switched-capacitor power converter according to an embodiment of the present disclosure. FIG. 6 shows another arrangement in which the first inductor L1 is disposed at an input side of the dual-phase resonant switched-capacitor power converter. The power stage 500 includes a first phase switched-capacitor circuit, a second phase switched-capacitor circuit, the first inductor L1, a second inductor L2, and an output capacitor Cout. The first inductor L1 is coupled between the input node receiving the input voltage Vin and the first phase switched-capacitor circuit and the second phase switched-capacitor circuit. The second inductor L2 is coupled between the second switch node Vx2 and the output node providing the output voltage Vout. The first phase switched-capacitor circuit and the second phase switched-capacitor circuit are coupled to the first inductor L1 and the second switch node Vx2 through corresponding switches.

During a 4:1 resonant operation, when a flying-capacitor set of one phase is connected in series, the first inductor L1 and the second inductor L2 are included in the series charging path between the input node and the output node. When a flying-capacitor set of another phase is connected in parallel, the second inductor L2 is included in the corresponding discharging path between the output node and the ground. The power stage 500 therefore provides an alternative arrangement of the first inductor L1 while maintaining the dual-phase resonant operation described with reference to FIG. 5. The first inductor L1 can be placed at the input side, and the second inductor L2 can remain at the output side so that the series charging path and the parallel discharging path retain the corresponding resonant elements.

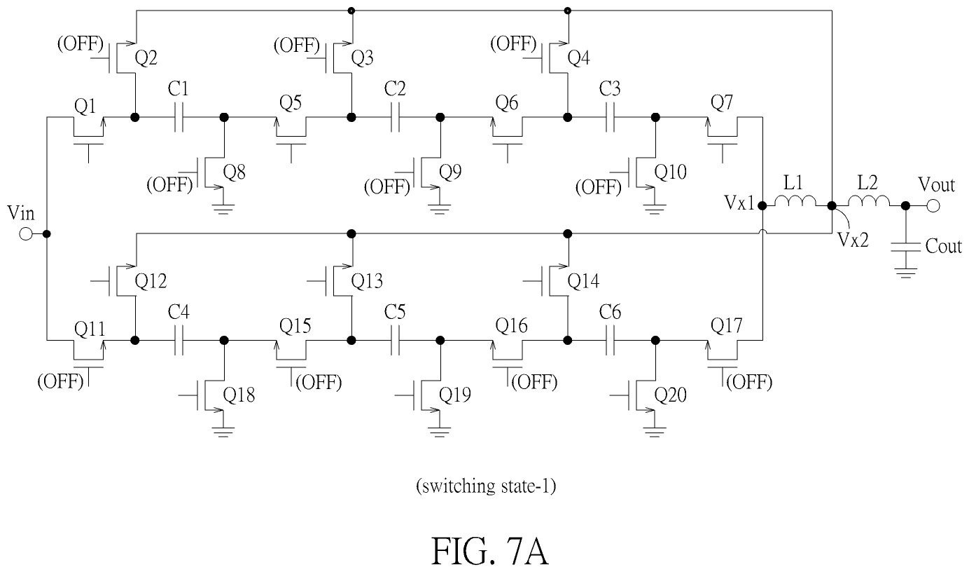

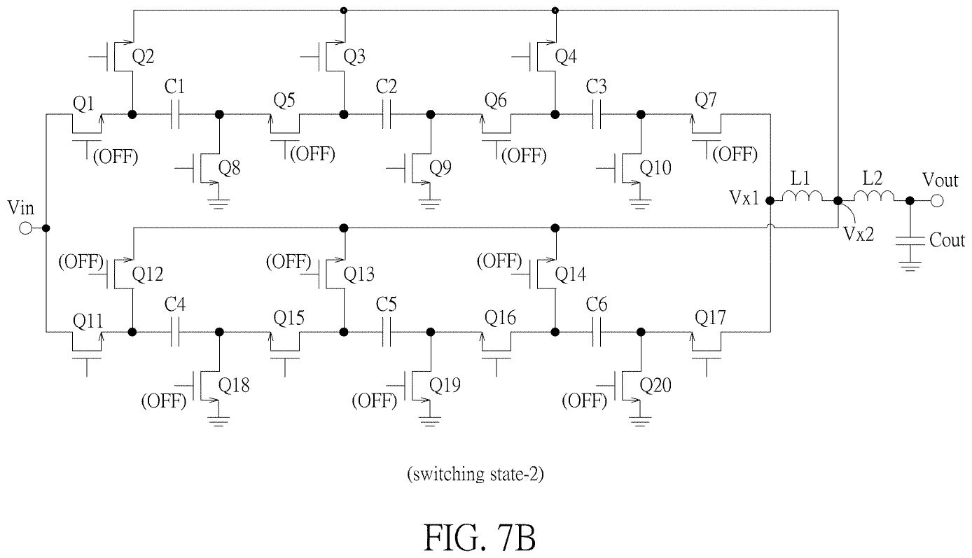

FIG. 7A is a circuit diagram illustrating a first switching state of the dual-phase resonant switched-capacitor power converter 400 operating in a 4:1 resonant mode according to an embodiment of the present disclosure. In the first switching state, the switches Q1, Q5, Q6, Q7, Q12, Q13, Q14, Q18, Q19, and Q20 are turned on, and the switches Q2, Q3, Q4, Q8, Q9, Q10, Q11, Q15, Q16, and Q17 are turned off. The flying capacitors C1 to C3 of the first phase switched-capacitor circuit are coupled in series with each other and with the first inductor L1 and the second inductor L2 between the input node and the output node. The flying capacitors C4 to C6 of the second phase switched-capacitor circuit are coupled in parallel with each other and in series with the second inductor L2 between the output node and the ground.

In the first switching state, a series charging current of the first phase switched-capacitor circuit flows from the input node, through the flying capacitors C1 to C3 connected in series, the first inductor L1, and the second inductor L2, toward the output node. A parallel discharging current of the second phase switched-capacitor circuit flows from the ground, through the flying capacitors C4 to C6 connected in parallel and the second inductor L2, toward the output node. Therefore, the first switching state causes the first phase switched-capacitor circuit to use a resonant path associated with the first inductor L1 and the second inductor L2, and causes the second phase switched-capacitor circuit to use a resonant path associated with the second inductor L2.

FIG. 7B is a circuit diagram illustrating a second switching state of the dual-phase resonant switched-capacitor power converter 400 operating in the 4:1 resonant mode according to an embodiment of the present disclosure. In the second switching state, the switches Q2, Q3, Q4, Q8, Q9, Q10, Q11, Q15, Q16, and Q17 are turned on, and the switches Q1, Q5, Q6, Q7, Q12, Q13, Q14, Q18, Q19, and Q20 are turned off. The flying capacitors C4 to C6 of the second phase switched-capacitor circuit are coupled in series with each other and with the first inductor L1 and the second inductor L2 between the input node and the output node. The flying capacitors C1 to C3 of the first phase switched-capacitor circuit are coupled in parallel with each other and in series with the second inductor L2 between the output node and the ground.

In the second switching state, a series charging current of the second phase switched-capacitor circuit flows from the input node, through the flying capacitors C4 to C6 connected in series, the first inductor L1, and the second inductor L2, toward the output node. A parallel discharging current of the first phase switched-capacitor circuit flows from the ground, through the flying capacitors C1 to C3 connected in parallel and the second inductor L2, toward the output node. Therefore, the second switching state causes the second phase switched-capacitor circuit to use a resonant path associated with the first inductor L1 and the second inductor L2, and causes the first phase switched-capacitor circuit to use a resonant path associated with the second inductor L2.

The first switching state shown in FIG. 7A and the second switching state shown in FIG. 7B are complementary switching states of the dual-phase 4:1 resonant mode. By alternating between the first switching state and the second switching state, the controller 420 alternately charges the flying capacitors of one phase in series and discharges the flying capacitors of another phase in parallel. The phase-shifted operation permits the power stage 410 to maintain power transfer while distributing resonant currents between the first phase switched-capacitor circuit and the second phase switched-capacitor circuit.

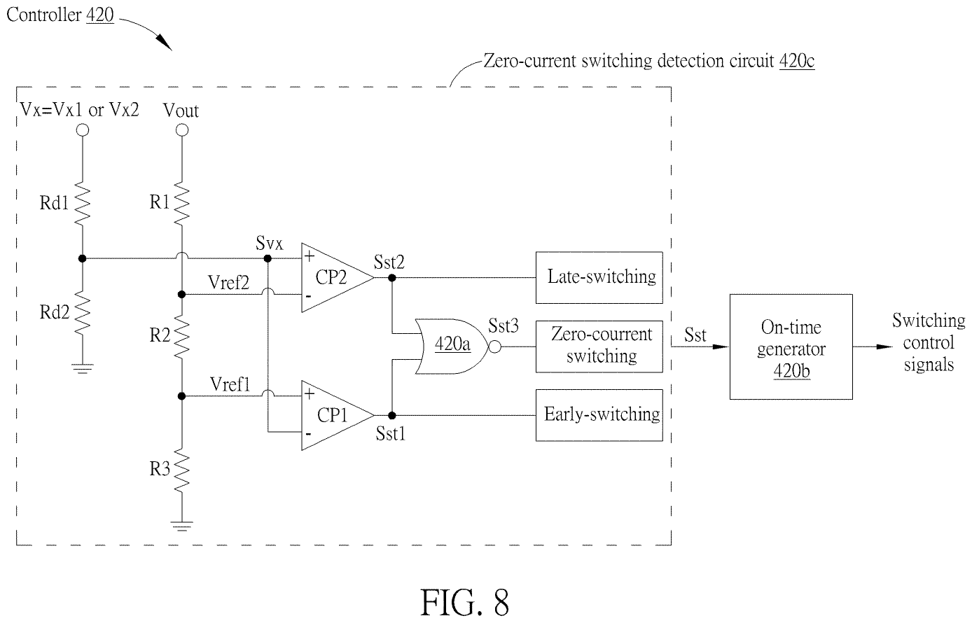

FIG. 8 is a circuit diagram of a zero-current switching detection circuit 420c and an on-time generator 420b according to an embodiment of the present disclosure. The controller 420 includes a zero-current switching detection circuit 420c and an on-time generator 420b. The zero-current switching detection circuit 420c receives a voltage of the switch node Vx. The switch node Vx can be the first switch node Vx1 or the second switch node Vx2. A resistor divider including resistors Rd1 and Rd2 generates a sensed voltage signal Svx based on the voltage of the switch node Vx.

Another resistor divider including resistors R1, R2, and R3 generates a first reference voltage Vref1 and a second reference voltage Vref2 based on the output voltage Vout. The first reference voltage Vref1 and the second reference voltage Vref2 define a voltage window for evaluating the sensed voltage signal Svx. The first comparator CP1 compares the sensed voltage signal Svx with the first reference voltage Vref1 to generate a first switching state signal Sst1. The second comparator CP2 compares the sensed voltage signal Svx with the second reference voltage Vref2 to generate a second switching state signal Sst2.

A NOR gate 420a receives the first switching state signal Sst1 and the second switching state signal Sst2 and generates a third switching state signal Sst3. The first switching state signal Sst1 can represent an early-switching state. The second switching state signal Sst2 can represent a late-switching state. The third switching state signal Sst3 can represent a zero-current switching state. A state signal Sst is provided to the on-time generator 420b based on the first switching state signal Sst1, the second switching state signal Sst2, and the third switching state signal Sst3. The on-time generator 420b generates switching control signals based on the state signal Sst.

The switch node Vx can be selected from the first switch node Vx1 or the second switch node Vx2, and the selected voltage of the switch node Vx can be used for detecting whether an inductor current of the second inductor L2 reaches a zero-current level. By sensing the voltage of the switch node Vx, the controller 420 can determine whether the present switching timing is early, late, or close to a zero-current switching condition. The on-time generator 420b can adjust the first on-time and the second on-time in response to the state signal Sst. Accordingly, the controller 420 can cause the inductor current of the second inductor L2 to reach a zero-current level during dead-time periods following the first on-time and the second on-time.

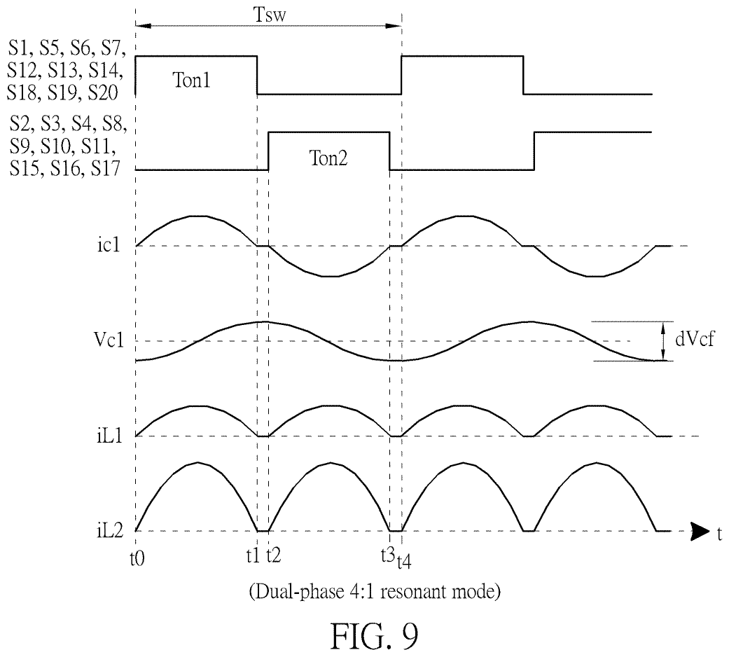

FIG. 9 is a waveform diagram of switching control signals and waveforms of the dual-phase resonant switched-capacitor power converter 400 operating in the 4:1 resonant mode according to an embodiment of the present disclosure. A first group of switching control signals includes S1, S5, S6, S7, S12, S13, S14, S18, S19, and S20. A second group of switching control signals includes S2, S3, S4, S8, S9, S10, S11, S15, S16, and S17. A switching period Tsw extends from time t0 to time t4. During a period from time t0 to time t1, the first group of switching control signals is activated, and the power stage 410 operates in the first switching state shown in FIG. 7A. During a period from time t1 to time t2, the power stage 410 operates in a dead-time period. During a period from time t2 to time t3, the second group of switching control signals is activated, and the power stage 410 operates in the second switching state shown in FIG. 7B. During a period from time t3 to time t4, the power stage 410 operates in another dead-time period.

The waveform diagram also illustrates a flying capacitor current ic1 of the flying capacitor C1, a flying capacitor voltage Vc1 of the flying capacitor C1, a first inductor current iL1 of the first inductor L1, and a second inductor current iL2 of the second inductor L2. The flying capacitor current ic1 has a resonant current waveform. The flying capacitor voltage Vc1 has a voltage ripple dVcf. The first inductor current iL1 and the second inductor current iL2 reach or approach a zero-current level during the dead-time periods. The first on-time Ton1 and the second on-time Ton2 can be equal or unequal, and the controller 420 can adjust the first on-time Ton1 and the second on-time Ton2 based on the zero-current switching detection result. The first on-time Ton1 can be associated with the equivalent circuit of FIG. 4A, and the second on-time Ton2 can be associated with the equivalent circuit of FIG. 4B.

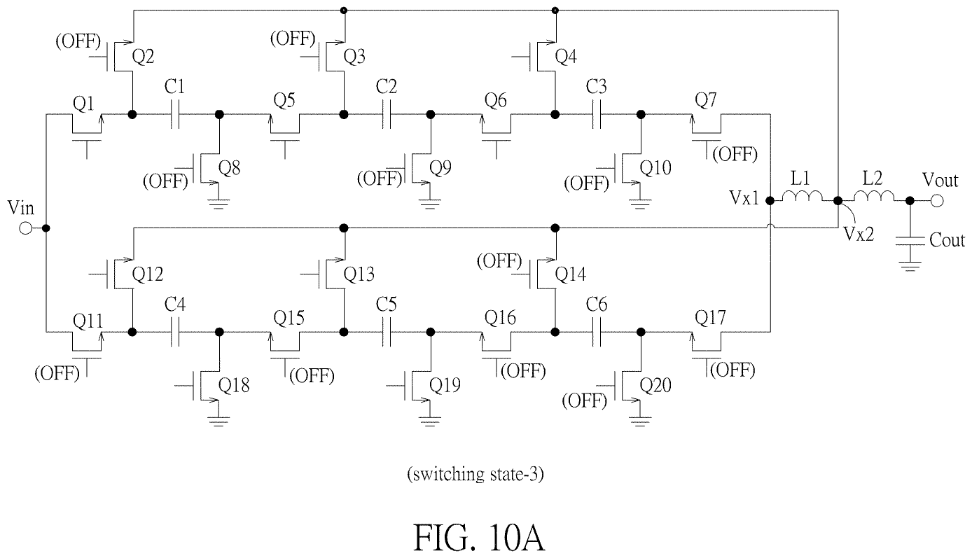

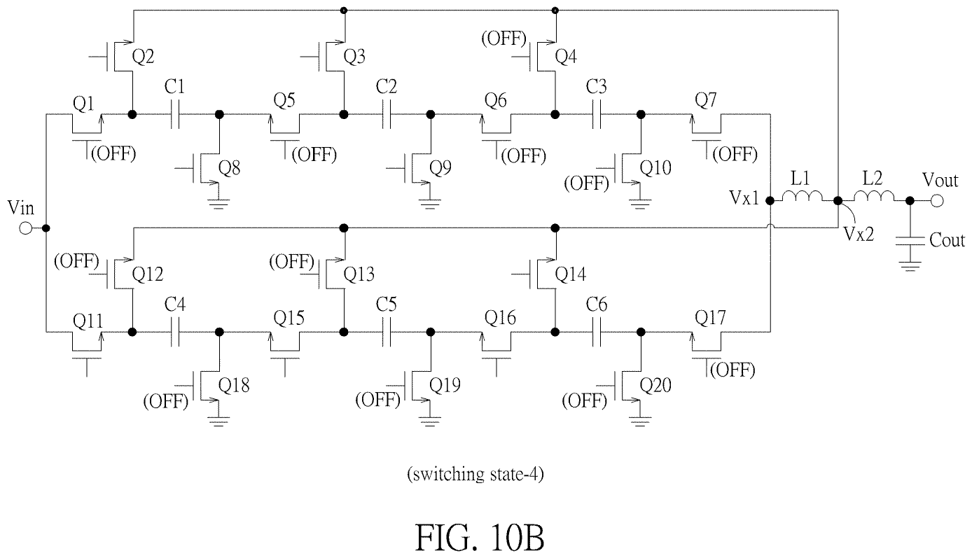

FIG. 10A is a circuit diagram illustrating a third switching state of the dual-phase resonant switched-capacitor power converter 400 operating in a 3:1 resonant mode according to an embodiment of the present disclosure. In the third switching state, the switches Q1, Q4, Q5, Q6, Q12, Q13, Q18, and Q19 are turned on, and the switches Q2, Q3, Q7, Q8, Q9, Q10, Q11, Q14, Q15, Q16, Q17, and Q20 are turned off. In the 3:1 resonant mode, one flying capacitor of each phase is disabled. In the third switching state, the flying capacitor C3 of the first phase switched-capacitor circuit and the flying capacitor C6 of the second phase switched-capacitor circuit are disabled. The switches Q7 and Q10 associated with the flying capacitor C3 are maintained off, and the switches Q17 and Q20 associated with the flying capacitor C6 are maintained off.

The flying capacitors C1 and C2 of the first phase switched-capacitor circuit are coupled in series with each other and with the second inductor L2 between the input node and the output node. The flying capacitors C4 and C5 of the second phase switched-capacitor circuit are coupled in parallel with each other and in series with the second inductor L2 between the output node and the ground. In the 3:1 resonant mode shown in FIG. 10A, the first inductor L1 is not included in the series charging path or the parallel discharging path of the remaining flying capacitors. The charging path uses two series-connected flying capacitors rather than three series-connected flying capacitors. Since the number of series-connected flying capacitors is reduced, a voltage deviation accumulated across the series-connected flying capacitors is smaller than a voltage deviation accumulated in the 4:1 resonant mode.

FIG. 10B is a circuit diagram illustrating a fourth switching state of the dual-phase resonant switched-capacitor power converter 400 operating in the 3:1 resonant mode according to an embodiment of the present disclosure. In the fourth switching state, the switches Q2, Q3, Q8, Q9, Q11, Q14, Q15, and Q16 are turned on, and the switches Q1, Q4, Q5, Q6, Q7, Q10, Q12, Q13, Q17, Q18, Q19, and Q20 are turned off. The flying capacitors C4 and C5 of the second phase switched-capacitor circuit are coupled in series with each other and with the second inductor L2 between the input node and the output node. The flying capacitors C1 and C2 of the first phase switched-capacitor circuit are coupled in parallel with each other and in series with the second inductor L2 between the output node and the ground.

By alternating between the third switching state and the fourth switching state, the controller 420 operates the dual-phase resonant switched-capacitor power converter 400 in the 3:1 resonant mode. During a first 3:1-mode on-time, the remaining flying capacitors C1 and C2 of the first phase switched-capacitor circuit are connected in series, and the remaining flying capacitors C4 and C5 of the second phase switched-capacitor circuit are connected in parallel. During a second 3:1-mode on-time, the remaining flying capacitors C4 and C5 of the second phase switched-capacitor circuit are connected in series, and the remaining flying capacitors C1 and C2 of the first phase switched-capacitor circuit are connected in parallel. In both 3:1-mode on-time periods, the remaining flying capacitor paths are associated with the second inductor L2 rather than the first inductor L1.

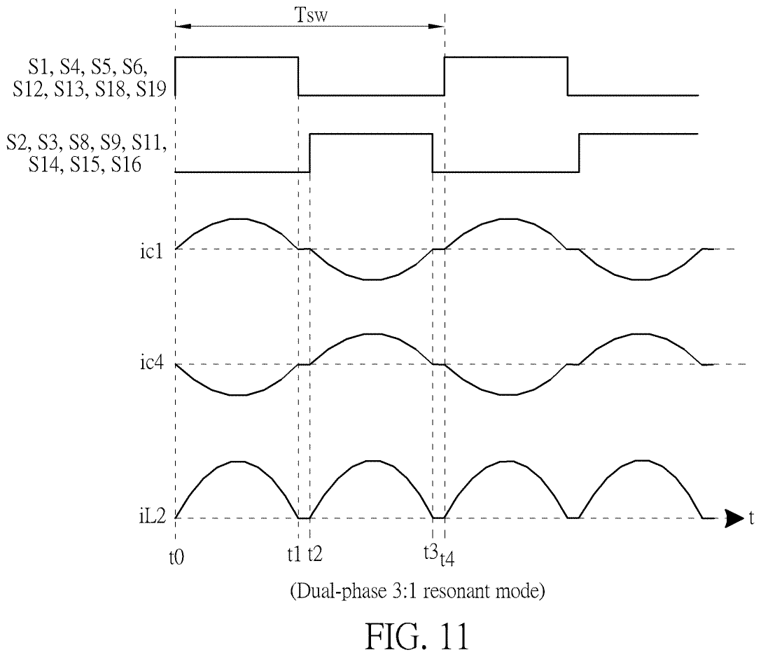

FIG. 11 is a waveform diagram of switching control signals and waveforms of the dual-phase resonant switched-capacitor power converter 400 operating in the 3:1 resonant mode according to an embodiment of the present disclosure. A first group of switching control signals includes S1, S4, S5, S6, S12, S13, S18, and S19. A second group of switching control signals includes S2, S3, S8, S9, S11, S14, S15, and S16. A switching period Tsw extends from time t0 to time t4. During a period from time t0 to time t1, the first group of switching control signals is activated, and the power stage 410 operates in the third switching state shown in FIG. 10A. During a period from time t1 to time t2, the power stage 410 operates in a dead-time period. During a period from time t2 to time t3, the second group of switching control signals is activated, and the power stage 410 operates in the fourth switching state shown in FIG. 10B. During a period from time t3 to time t4, the power stage 410 operates in another dead-time period.

The waveform diagram illustrates a flying capacitor current ic1 of the flying capacitor C1, a flying capacitor current ic4 of the flying capacitor C4, and a second inductor current iL2. The flying capacitor currents ic1 and ic4 correspond to the first phase switched-capacitor circuit and the second phase switched-capacitor circuit, respectively. The second inductor current iL2 reaches or approaches the zero-current level during the dead-time periods. Since the 3:1 resonant mode uses fewer series-connected flying capacitors than the 4:1 resonant mode, the accumulated voltage deviation during switching-state transitions is smaller.

The 2:1 resonant mode can be understood from the same mode-selection principle. In the 2:1 resonant mode, two flying capacitors of each phase are disabled, and only one remaining flying capacitor of each phase participates in the operation. For example, in the first phase switched-capacitor circuit, the flying capacitors C2 and C3 can be disabled, and the switches Q6, Q7, Q9, and Q10 associated with the disabled flying capacitors can be maintained off. In the second phase switched-capacitor circuit, the flying capacitors C5 and C6 can be disabled, and the switches Q16, Q17, Q19, and Q20 associated with the disabled flying capacitors can be maintained off. Accordingly, the flying capacitor C1 of the first phase switched-capacitor circuit and the flying capacitor C4 of the second phase switched-capacitor circuit remain operative. In the 2:1 resonant mode, a charging path and a discharging path of the remaining flying capacitor of each phase are associated with the second inductor L2 rather than the first inductor L1.

Since only one flying capacitor of each phase is used in the 2:1 resonant mode, a voltage deviation caused by a series connection of a plurality of flying capacitors is not accumulated in the same manner as in the 4:1 resonant mode, and waveform behavior is substantially not affected by the absence of the first inductor L1 in the remaining flying capacitor paths.

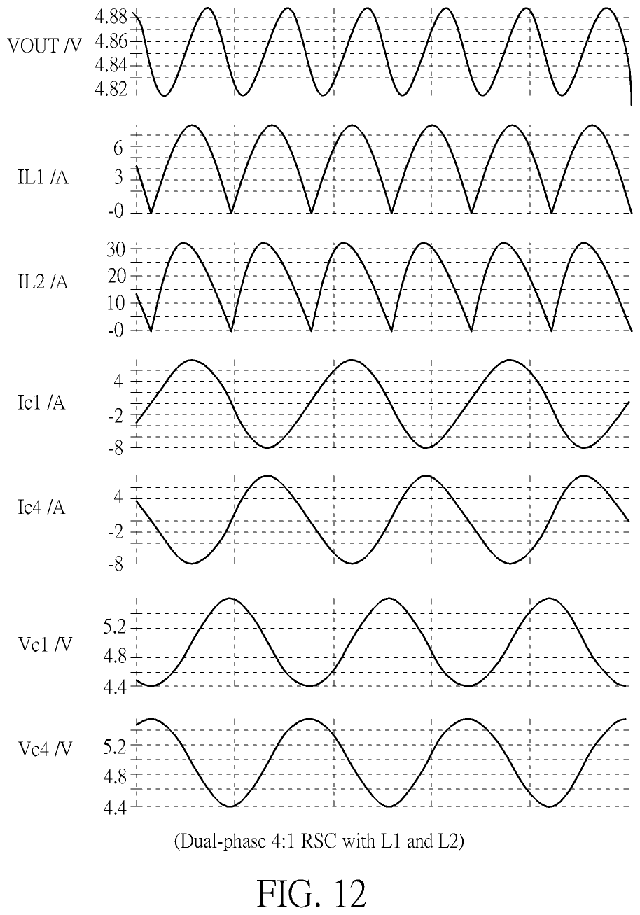

FIG. 12 is a simulation waveform diagram of the dual-phase resonant switched-capacitor power converter 400 operating in the 4:1 resonant mode with a first inductor L1 and a second inductor L2 according to an embodiment of the present disclosure. The simulation waveforms include an output voltage VOUT, a first inductor current IL1 of the first inductor L1, a second inductor current IL2 of the second inductor L2, a flying capacitor current Ic1 of the flying capacitor C1, a flying capacitor current Ic4 of the flying capacitor C4, a flying capacitor voltage Vc1 of the flying capacitor C1, and a flying capacitor voltage Vc4 of the flying capacitor C4.

The first inductor current IL1 and the second inductor current IL2 have resonant current pulses. The second inductor current IL2 can be larger than the first inductor current IL1 because three flying capacitors can be coupled in parallel and discharge through the second inductor L2 during a parallel discharging state. The flying capacitor currents Ic1 and Ic4 also have resonant current waveforms corresponding to the interleaved operation of the first phase switched-capacitor circuit and the second phase switched-capacitor circuit.

In the 4:1 resonant mode, three flying capacitors can be connected in series during a series charging operation. A voltage deviation of each flying capacitor can be accumulated along the series-connected path. The first inductor L1 participates in the 4:1 series charging path and shares a portion of a voltage difference generated during switching-state transitions. The second inductor L2 participates in both the series charging path and the parallel discharging path. Therefore, the first inductor L1 and the second inductor L2 distribute the voltage difference across the resonant paths. The flying capacitor currents Ic1 and Ic4 shown in FIG. 12 have smoother resonant waveforms than waveforms generated under a condition in which the first inductor L1 is replaced by a short circuit.

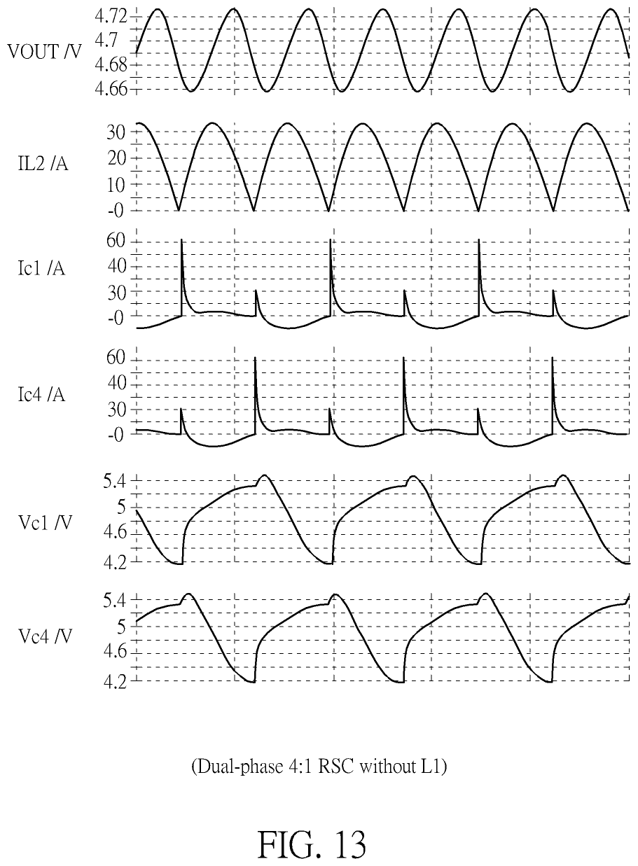

FIG. 13 is a simulation waveform diagram of the dual-phase resonant switched-capacitor power converter 400 operating in the 4:1 resonant mode without the first inductor L1 according to an embodiment of the present disclosure. The simulation waveforms include an output voltage VOUT, a second inductor current IL2 of the second inductor L2, a flying capacitor current Ic1 of the flying capacitor C1, a flying capacitor current Ic4 of the flying capacitor C4, a flying capacitor voltage Vc1 of the flying capacitor C1, and a flying capacitor voltage Vc4 of the flying capacitor C4. FIG. 13 illustrates a comparative condition in which the first inductor L1 is replaced by a short circuit.

In the comparative condition, a voltage deviation of each flying capacitor can be accumulated when a plurality of flying capacitors are connected in series during a switching-state transition. For example, if each of three flying capacitors has a voltage deviation of about 0.5V, an accumulated voltage deviation of the three flying capacitors connected in series can be about 1.5V. If another capacitor path has a voltage deviation of about 0.5V, a voltage difference of about 1V can be generated between the capacitor paths during the switching-state transition. When the first inductor L1 is replaced by a short circuit, the voltage difference is applied more directly to the flying capacitor paths. Accordingly, transient currents through the flying capacitors are increased, and the flying capacitor currents Ic1 and Ic4 include switching current spikes.

The comparative condition of FIG. 13 explains why the first inductor L1 is significant in the 4:1 resonant mode. In the 4:1 resonant mode, three flying capacitors of one phase can be connected in series, and three flying capacitors of another phase can be connected in parallel. A voltage difference between the two capacitor paths can be produced when the switching state changes. With the first inductor L1, a portion of the voltage difference can be distributed across the first inductor L1 rather than being applied directly to the flying capacitor paths. Without the first inductor L1, the voltage difference can drive larger transient currents in the flying capacitor paths. In contrast, as shown in FIG. 12, the first inductor L1 can share a portion of the voltage difference, and the flying capacitor currents can have smoother resonant waveforms.

This also explains why the waveform behavior in the 3:1 resonant mode is less affected when the first inductor L1 is not included in the remaining flying capacitor paths. In the 3:1 resonant mode, only two flying capacitors are connected in series during a series charging operation. Therefore, the accumulated voltage deviation caused by the series-connected flying capacitors is smaller than that in the 4:1 resonant mode using three series-connected flying capacitors. In the 2:1 resonant mode, only one remaining flying capacitor of each phase participates in the operation, and therefore a voltage deviation caused by a series connection of a plurality of flying capacitors is not accumulated in the same manner. Accordingly, the waveform behavior in the 2:1 resonant mode is substantially not affected by the absence of the first inductor L1 in the remaining flying capacitor paths.

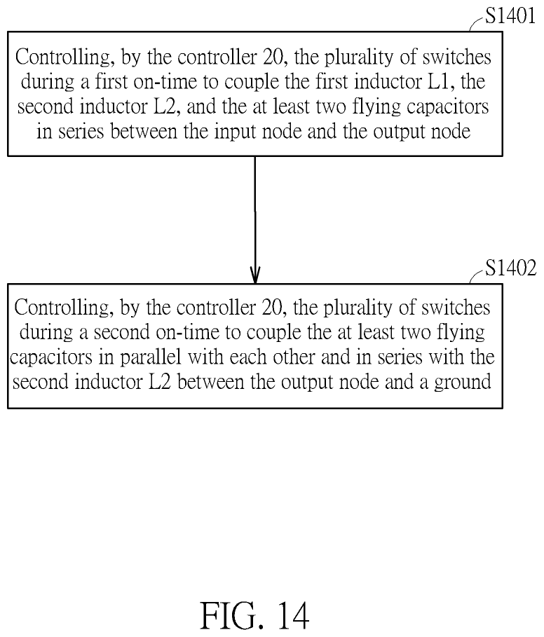

FIG. 14 is a flowchart illustrating a method of operating the switched-capacitor power converter 100 according to an embodiment of the present disclosure. The method includes steps S1401 to S1402. Any hardware or technology modification falls into the scope of the present disclosure. Steps S1401 to S1402 are illustrated below.
step S1401: controlling, by the controller 20, the plurality of switches during a first on-time to couple the first inductor L1, the second inductor L2, and the at least two flying capacitors in series between the input node and the output node;
step S1402: controlling, by the controller 20, the plurality of switches during a second on-time to couple the at least two flying capacitors in parallel with each other and in series with the second inductor L2 between the output node and a ground.

Details of steps S1401 to S1402 have been previously described, and therefore are not repeated herein. By performing steps S1401 to S1402, the switched-capacitor power converter 100 forms different resonant paths during different on-time periods. During the first on-time, the first inductor L1, the second inductor L2, and the at least two flying capacitors are coupled in series so that the first inductor L1 participates in the resonant charging path. During the second on-time, the at least two flying capacitors are coupled in parallel with each other and in series with the second inductor L2 so that energy stored in the flying capacitors can be transferred through the second inductor L2. The different resonant paths permit the controller 20 to coordinate the first on-time and the second on-time with the resonant characteristics of the power stage 10, thereby supporting resonant operation and zero-current switching control.

In summary, the switched-capacitor power converters and operating methods of the present disclosure provide resonant operation by using a first inductor, a second inductor, and flying capacitors arranged in different resonant paths during different on-time periods. In a first on-time, the first inductor, the second inductor, and the flying capacitors can be coupled in series between an input node and an output node. In a second on-time, the flying capacitors can be coupled in parallel with each other and in series with the second inductor between the output node and a ground. The controller can adjust on-times based on zero-current switching detection, and the converter can support 4:1, 3:1, and 2:1 resonant modes. The dual-phase embodiments further provide interleaved operation by using two flying-capacitor sets with shared inductors. As a result, the disclosed embodiments provide a flexible switched-capacitor power conversion architecture suitable for high-density resonant power conversion.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method of operating a switched-capacitor power converter for converting power between an input node and an output node, the switched-capacitor power converter comprising a controller, a plurality of switches, a first inductor, a second inductor, and at least two flying capacitors, the method comprising:
controlling, by the controller, the plurality of switches during a first on-time to couple the first inductor, the second inductor, and the at least two flying capacitors in series between the input node and the output node; and
controlling, by the controller, the plurality of switches during a second on-time to couple the at least two flying capacitors in parallel with each other and in series with the second inductor between the output node and a ground.

2. The method of claim 1, further comprising:
adjusting, by the controller, the first on-time and the second on-time based on a zero-current switching detection result such that an inductor current of the second inductor reaches a zero-current level during dead-time periods following the first on-time and the second on-time.

3. The method of claim 2, wherein the zero-current switching detection result is generated by sensing, by the controller, a voltage of a switch node, wherein the switch node is one of a first switch node and a second switch node of the switched-capacitor power converter, generating a sensed voltage signal based on the voltage of the switch node, and comparing the sensed voltage signal with a first reference voltage and a second reference voltage generated based on an output voltage at the output node.

4. The method of claim 1, wherein the first on-time is based on a first resonant period associated with the first inductor, the second inductor, and a series equivalent capacitance of the at least two flying capacitors, and wherein the second on-time is based on a second resonant period associated with the second inductor and a parallel equivalent capacitance of the at least two flying capacitors.

5. The method of claim 4, wherein an inductance of the first inductor is greater than an inductance of the second inductor, and wherein the first resonant period and the second resonant period are substantially equal.

6. The method of claim 1, wherein the at least two flying capacitors comprise three flying capacitors, wherein the controlling during the first on-time comprises coupling the three flying capacitors in series between the input node and the output node, and wherein the controlling during the second on-time comprises coupling the three flying capacitors in parallel with each other between the output node and the ground.

7. The method of claim 6, wherein the at least two flying capacitors form a first flying-capacitor set, wherein the switched-capacitor power converter further comprises a second flying-capacitor set comprising three flying capacitors, and wherein the controller operates the first flying-capacitor set and the second flying-capacitor set with a phase shift such that:
during the first on-time, the flying capacitors of the first flying-capacitor set are coupled in series with each other and with the first inductor and the second inductor between the input node and the output node, and the flying capacitors of the second flying-capacitor set are coupled in parallel with each other and in series with the second inductor between the output node and the ground; and
during the second on-time, the flying capacitors of the second flying-capacitor set are coupled in series with each other and with the first inductor and the second inductor between the input node and the output node, and the flying capacitors of the first flying-capacitor set are coupled in parallel with each other and in series with the second inductor between the output node and the ground.

8. The method of claim 7, further comprising:
operating, by the controller, the switched-capacitor power converter in a 3:1 resonant mode by disabling one flying capacitor of the first flying-capacitor set and one flying capacitor of the second flying-capacitor set, and by controlling remaining flying capacitors of the first flying-capacitor set and remaining flying capacitors of the second flying-capacitor set with the phase shift such that:
during a first 3:1-mode on-time, the remaining flying capacitors of the first flying-capacitor set are coupled in series with each other and with the second inductor between the input node and the output node, and the remaining flying capacitors of the second flying-capacitor set are coupled in parallel with each other and in series with the second inductor between the output node and the ground; and
during a second 3:1-mode on-time, the remaining flying capacitors of the second flying-capacitor set are coupled in series with each other and with the second inductor between the input node and the output node, and the remaining flying capacitors of the first flying-capacitor set are coupled in parallel with each other and in series with the second inductor between the output node and the ground.

9. The method of claim 7, further comprising:
operating, by the controller, the switched-capacitor power converter in a 2:1 resonant mode by disabling two flying capacitors of the first flying-capacitor set and two flying capacitors of the second flying-capacitor set, and by controlling a remaining flying capacitor of the first flying-capacitor set and a remaining flying capacitor of the second flying-capacitor set with the phase shift such that:
during a first 2:1-mode on-time, the remaining flying capacitor of the first flying-capacitor set is coupled in series with the second inductor between the input node and the output node, and the remaining flying capacitor of the second flying-capacitor set is coupled in series with the second inductor between the output node and the ground; and
during a second 2:1-mode on-time, the remaining flying capacitor of the second flying-capacitor set is coupled in series with the second inductor between the input node and the output node, and the remaining flying capacitor of the first flying-capacitor set is coupled in series with the second inductor between the output node and the ground.

10. The method of claim 1, wherein at least one of the first inductor and the second inductor comprises a conductive path of a printed circuit board, a conductive path of an integrated circuit, or a package lead.

11. A switched-capacitor power converter, comprising:
an input node;
an output node;
a power stage coupled between the input node and the output node, the power stage comprising a plurality of switches, a first inductor, a second inductor, and at least two flying capacitors; and
a controller coupled to the plurality of switches and configured to:
control the plurality of switches during a first on-time to couple the first inductor, the second inductor, and the at least two flying capacitors in series between the input node and the output node; and
control the plurality of switches during a second on-time to couple the at least two flying capacitors in parallel with each other and in series with the second inductor between the output node and a ground.

12. The switched-capacitor power converter of claim 11, wherein the controller is further configured to adjust the first on-time and the second on-time based on a zero-current switching detection result such that an inductor current of the second inductor reaches a zero-current level during dead-time periods following the first on-time and the second on-time.

13. The switched-capacitor power converter of claim 12, wherein the controller is configured to generate the zero-current switching detection result by sensing a voltage of a switch node, wherein the switch node is one of a first switch node and a second switch node of the switched-capacitor power converter, generating a sensed voltage signal based on the voltage of the switch node, and comparing the sensed voltage signal with a first reference voltage and a second reference voltage generated based on an output voltage at the output node.

14. The switched-capacitor power converter of claim 11, wherein the first on-time is based on a first resonant period associated with the first inductor, the second inductor, and a series equivalent capacitance of the at least two flying capacitors, and wherein the second on-time is based on a second resonant period associated with the second inductor and a parallel equivalent capacitance of the at least two flying capacitors.

15. The switched-capacitor power converter of claim 14, wherein an inductance of the first inductor is greater than an inductance of the second inductor, and wherein the first resonant period and the second resonant period are substantially equal.

16. The switched-capacitor power converter of claim 11, wherein the at least two flying capacitors comprise three flying capacitors, wherein the controller is configured to control the plurality of switches during the first on-time to couple the three flying capacitors in series between the input node and the output node, and wherein the controller is configured to control the plurality of switches during the second on-time to couple the three flying capacitors in parallel with each other between the output node and the ground.

17. The switched-capacitor power converter of claim 16, wherein the at least two flying capacitors form a first flying-capacitor set, wherein the power stage further comprises:
a second flying-capacitor set comprising three flying capacitors, and wherein the controller is configured to operate the first flying-capacitor set and the second flying-capacitor set with a phase shift such that:
during the first on-time, the flying capacitors of the first flying-capacitor set are coupled in series with each other and with the first inductor and the second inductor between the input node and the output node, and the flying capacitors of the second flying-capacitor set are coupled in parallel with each other and in series with the second inductor between the output node and the ground; and
during the second on-time, the flying capacitors of the second flying-capacitor set are coupled in series with each other and with the first inductor and the second inductor between the input node and the output node, and the flying capacitors of the first flying-capacitor set are coupled in parallel with each other and in series with the second inductor between the output node and the ground.

18. The switched-capacitor power converter of claim 17, wherein the controller is further configured to operate the switched-capacitor power converter in a 3:1 resonant mode by disabling one flying capacitor of the first flying-capacitor set and one flying capacitor of the second flying-capacitor set, and by controlling remaining flying capacitors of the first flying-capacitor set and remaining flying capacitors of the second flying-capacitor set with the phase shift such that:
during a first 3:1-mode on-time, the remaining flying capacitors of the first flying-capacitor set are coupled in series with each other and with the second inductor between the input node and the output node, and the remaining flying capacitors of the second flying-capacitor set are coupled in parallel with each other and in series with the second inductor between the output node and the ground; and
during a second 3:1-mode on-time, the remaining flying capacitors of the second flying-capacitor set are coupled in series with each other and with the second inductor between the input node and the output node, and the remaining flying capacitors of the first flying-capacitor set are coupled in parallel with each other and in series with the second inductor between the output node and the ground.

19. The switched-capacitor power converter of claim 17, wherein the controller is further configured to operate the switched-capacitor power converter in a 2:1 resonant mode by disabling two flying capacitors of the first flying-capacitor set and two flying capacitors of the second flying-capacitor set, and by controlling a remaining flying capacitor of the first flying-capacitor set and a remaining flying capacitor of the second flying-capacitor set with the phase shift such that:
during a first 2:1-mode on-time, the remaining flying capacitor of the first flying-capacitor set is coupled in series with the second inductor between the input node and the output node, and the remaining flying capacitor of the second flying-capacitor set is coupled in series with the second inductor between the output node and the ground; and
during a second 2:1-mode on-time, the remaining flying capacitor of the second flying-capacitor set is coupled in series with the second inductor between the input node and the output node, and the remaining flying capacitor of the first flying-capacitor set is coupled in series with the second inductor between the output node and the ground.

20. The switched-capacitor power converter of claim 11, wherein at least one of the first inductor and the second inductor comprises a conductive path of a printed circuit board, a conductive path of an integrated circuit, or a package lead.
